(19) United States
(12) Patent Application Publication
(10) Pub. No.: US 2026/0264779 A1
(43) Pub. Date: Sep. 10, 2026

(54) TRACK LINK WITH BLIND HOLE AND ASSEMBLY THEREOF

(71) Applicant: Caterpillar Inc., Peoria, IL (US)

(72) Inventor: Eric J. JOHANNSEN, Washington, IL (US)

(73) Assignee: Caterpillar Inc., Peoria, IL (US)

(21) Appl. No.: 19/072,378

(22) Filed: Mar. 6, 2025

(51) Int. Cl. B62D 55/21

(52) U.S. Cl. CPC B62D 55/21

(57) ABSTRACT

A track link includes an inner side; an outer side; a first longitudinal end including a busing aperture extending entirely through the track link from the inner side to the outer side; and a second longitudinal end including a blind hole extending only partially through the track link from the inner side toward the outer side.

### TECHNICAL FIELD

The present disclosure relates generally to a track link assembly for a machine, and more particularly, to a coupling arrangement for adjacent track links for a machine.

### BACKGROUND

Track type machines typically utilize track chains on each side of the machine to engage the ground surface to propel the machine. Individual links that form the track chains are connected to ground engaging elements, known as track shoes, to move the machine. A sprocket, driven by an engine of the machine, engages and translates the track chain about spaced apart rollers and one or more idlers. As the track chain translates, the connected track shoes engage a ground surface under the machine and propel the machine on the ground surface. The track chains are made of track links coupled together, typically by bushings and pins. Track chains can be broadly classified as straight link chains and offset link chains. Straight link chains have alternate inner and outer track links that are coupled together while, in an offset link chain, each track link is aligned with the next. Regardless of the type of track chain, the track links that comprise the track chain often require grease or oil as a lubricant between the bushings and pins to prevent galling (or other wear) and extend the usable lifetime of the track chain. Still, these track chains wear over time and may need to be replaced or serviced. As such, costs of production and maintenance are often important considerations in the design, manufacture, and assembly of the track chain. In particular, pins are traditionally press fitted into track links, which prevents the pins from rotating. As such, this arrangement causes an uneven wear pattern on the pins that may limit or decrease the usable lifetime of the pins.

An exemplary track chain is disclosed in U.S. Pat. No. 11,008,057 (“the '057 patent”) issued to Sho, et al. The '057 patent discloses one track link assembly (FIG. 3) in which track links are connected by connecting pins 7. When connected, one track link 1 and the other track link 1 are rotatable relative to each other about connecting pin 7. To prevent the removal of connecting pin 7, restriction members (for example, a bolt 8 and a nut 9) are used. Restriction members 8, 9 are positioned in the axial direction of connecting pin 7 in a state where restriction members 8, 9 are mounted on a link body 3. Due to restricting members 8, 9, the axial movement of connecting pin 7 is restricted. With such a configuration, the removal of connecting pin 7 from through holes 3 can be achieved by removing restricting members 8, 9. While the link assembly of the '057 patent may be suitable for some applications, it may not be suitable for other applications.

The track links and track link assemblies of the present disclosure may solve one or more of the problems set forth above or other problems in the art. The scope of the protection provided by the present disclosure, however, is defined by the attached claims, and not by the ability to solve any specific problem.

### SUMMARY

In one aspect, a track link comprises: an inner side; an outer side; a first longitudinal end including a bushing aperture extending entirely through the track link from the inner side to the outer side; and a second longitudinal end including a blind hole extending only partially through the track link from the inner side toward the outer side.

In another aspect, a track link assembly comprises: a first track link including a first blind hole extending only partially through the first track link and a first bushing aperture extending entirely through the first track link; a second track link including a second blind hole extending only partially through the second track link and a second bushing aperture extending entirely through the second track link; and a coupling assembly coupling the first track link and the second track link via the first blind hole and the second blind hole.

In another aspect, a track link comprises: an inner side; an outer side; a first longitudinal end including a bushing aperture extending entirely through the track link from the inner side to the outer side; and a second longitudinal end including a blind hole extending only partially through the track link from the inner side toward the outer side and forming a link cap integral to the track link.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective and partially exploded view of exemplary track links and track link assemblies of a track chain in accordance with the present disclosure.

FIG. 2 is a cut-away view of a portion of the track link assembly of FIG. 1.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

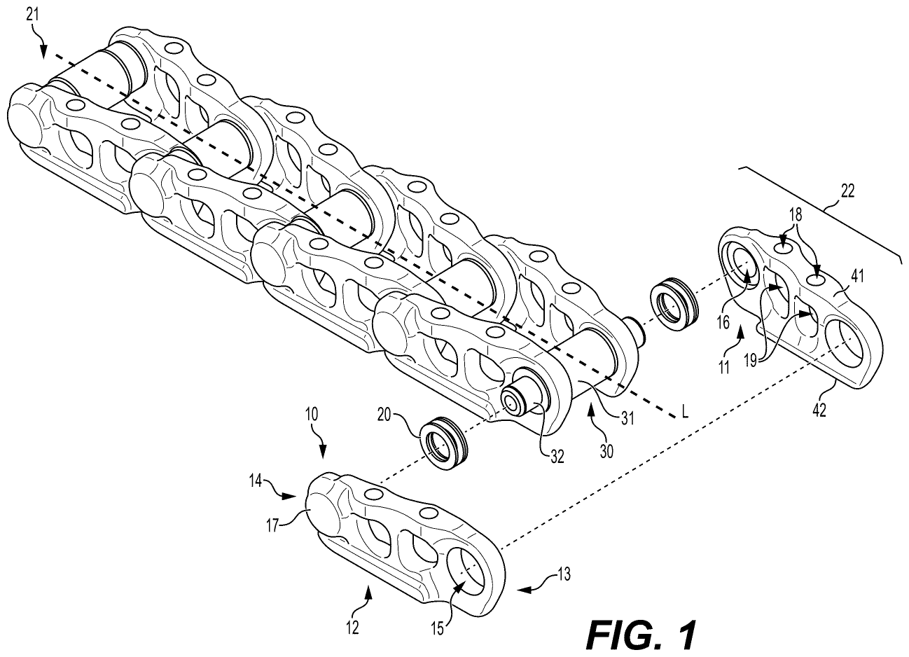

FIG. 1 illustrates a perspective and partially exploded view of an exemplary track chain 21, the track chain 21 including track link assemblies 22 including track links 10, according to an embodiment of the present disclosure. Track chain 21 may be coupled to any mobile machine that performs any type of operation for an industry such as mining, construction, farming, transportation, or any other industry known in the art. For example, track chain 21 may be coupled to an undercarriage assembly and driven by a power source of an excavator, a dozer, a loader, a backhoe, a motor grader, or any other earth moving machine. A separate track chain 21 may be coupled to each side of the machine and form separate endless loops. Although not shown, a plurality of track shoes may be coupled to an outer surface of track chain 21 in order to aid in the engagement of a ground surface.

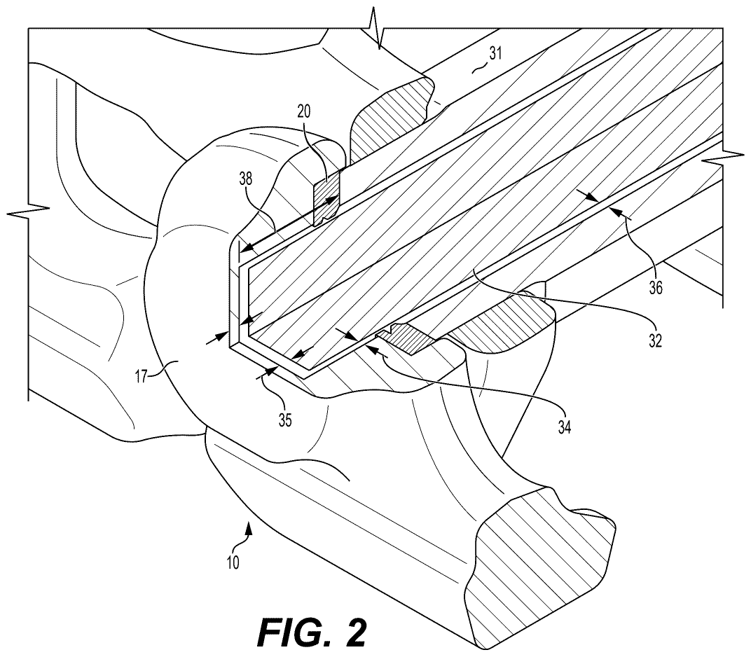

As shown in FIG. 1, track chain 21 may be an offset link chain that includes multiple structurally similar track link assemblies 22 arranged along a central and longitudinal axis L of the track chain 21 and the track link assemblies 22. Each track link assembly 22 includes a pair of laterally spaced apart and offset track links 10, e.g., the track links 10 of the track link assembly 22 are spaced apart along an axis orthogonal to the longitudinal axis L. Each track link 10 includes an inner side 11, an outer side 12, a top side 41, a bottom side 42, a first longitudinal end 13, and a second longitudinal end 14. Each track link 10 further includes a bushing aperture 15, which may be disposed at the first longitudinal end 13, and a blind hole 16, which may be disposed at the second longitudinal end 14. As shown in FIG. 1, the bushing aperture 15 extends entirely through the track link 10 from the inner side 11 of the track link 10 to the outer side 12 of the track link 10, while the blind hole 16 extends only partially through the track link 10 from the inner side 11 toward the outer side 12. The bushing aperture 15 and the blind hole 16 may be laterally offset, such that, for example, when the track link 10 is incorporated into a track chain 21, the bushing aperture 15 is laterally inward when compared to the blind hole 16, e.g., a distance between the longitudinal axis L and the bushing aperture 15 is less than a distance between the longitudinal axis L and the blind hole 16. By extending only partially through the track link 10, the blind hole 16 forms a link cap 17 at the outer side 12 of the track link 10. The link cap 17 may be flat (e.g., planar) on the outer side 12 of the track link 10. A thinnest portion of the link cap 17 may include a thickness 37 (FIG. 2) of approximately 5 mm to 10 mm.

Still referring to FIG. 1, each track link 10 may include a plurality of shoe holes 18, for example, on a surface of the top side 41 or the bottom side 42 of the track links 10 in order for a track shoe (not shown) to be coupled to the track link 10. Shoe holes 18 may extend as through-holes to central cavities or holes 19, for receiving a bolt and nut assembly to secure the track shoe to the track link 10. Central holes 19 may be positioned longitudinally between the bushing aperture 15 and the blind hole 16 on the track link 10. Additionally, central holes 19 may help to reduce the amount of material necessary to form a track link 10 or the weight of the track link 10 without substantially impacting the structural characteristics of the track link 10.

Still referring to FIG. 1, each track link assembly 22 may include a first track link 10, a second track link 10, and a coupling mechanism 30 coupling the first track link 10 to the second track link 10. The first track link 10 and the second track link 10 may be chiral to one another. The coupling mechanism 30 includes a cylindrical bushing 31 and a cylindrical pin 32 disposed within the bushing 31. A radial clearance 36 may exist between the bushing 31 and the pin 32. The radial clearance 36 between the bushing 31 and the pin 32 may be from approximately 0.2 mm to 0.6 mm. Grease may be disposed between the bushing 31 and the pin 32, e.g., within the radial clearance 36 between the bushing 31 and the pin 32, to reduce friction within the coupling mechanism 30. A seal 20 may be disposed between the coupling mechanism 30 and each of the first and second track links 10 to extend the useful lifetime of the track link assembly 22, such as by preventing grease disposed between the bushing 31 and the pin 32 from escaping the coupling mechanism 30. The pin 32 extends beyond the bushing 31 in both axial directions and is received within a cylindrical cavity defined by the first blind hole 16 of the first track link 10 and within a cylindrical cavity defined by the second blind hole 16 of the second track link 10, thereby coupling the first and second track links 10. The pin 32 may extend beyond the bushing 31 by a distance 38 equal to at least half of the diameter of the pin 32.

As shown in FIG. 1, the coupling mechanism 30 may further couple a first track link assembly 22 of a track chain 21 to a second track link assembly 22 of the track chain 21, such as by 1) the bushing 31 and the pin 32 first being disposed with the bushing apertures 15 of the track links 10 of the first track link assembly 22 and 2) the pin 32 then being received by the blind holes 16 of the track links 10 of the second track link assembly 22. In this way, the first track link assembly 22 and the second track link assembly 22 may be rotatably coupled. A plurality of track link assemblies 22 may be coupled together to form the track chain 21. Additionally, although not shown, the track chain 21 may include a master track link assembly that couples two free ends of the track chain 21 to form an endless loop.

Referring now to FIG. 2, the bushing aperture 15 may be circular and may include a diameter substantially equal to or slightly smaller than the diameter of the bushing 31, such that the bushing 31 is interference fitted or press fitted within the bushing aperture 15 when the bushing 31 is disposed within the bushing aperture 15, thereby preventing the bushing 31 from rotating within the bushing aperture 15. In contrast, the cylindrical cavity defined by the blind hole 16 includes a diameter that is larger than the diameter of the pin 32, such that a radial clearance 34 may exist between the pin 32 and the blind hole 16, thereby allowing the pin 32 to rotate within the blind hole 16. The radial clearance 34 between the pin 32 and the blind hole 16 may be from approximately 0.2 mm to 0.6 mm. When a track link 10 is incorporated into a track link assembly 22, e.g., when the track link 10 is coupled to another track link 10 by the coupling mechanism 30, an axial clearance 35 may exist between the pin 32 and the link cap 17 of the blind hole 16 of the track link 10, thereby allowing the pin 32 to rotate within the blind hole 16 and translate axially within both the blind hole 16 and the bushing 31.

### Industrial Applicability

The disclosed aspects of the track link 10, the track link assembly 22, and the track chain 21 may be used in any machine that employs a tracked undercarriage that includes track links coupled together to form one or more track chains. The track link 10 and the track link assembly 22 described herein may provide a strong and durable connection between track links 10, with a reduced number of components or a lower likelihood of requiring maintenance or replacement. Thus, the disclosed track link 10 and track link assembly 22 may be reliable and low cost, without sacrificing performance.

As mentioned above, the pins included in a track chain are traditionally press fitted into track links to prevent the pins from translating axially, thereby keeping the track chain intact. However, press fitting the pins into the track links prevents the pins from rotating and causes an uneven wear pattern on the pins that may limit or decrease the usable lifetime of pins.

The track link 10 of the present disclosure includes a blind hole 16 that forms a link cap 17. Two track links 10 may be coupled within a track link assembly 22 via the blind holes 16 of the track links 10 by a coupling mechanism 30 including a bushing 31 and a pin 32 disposed within the bushing 31. A radial clearance exists between the bushing 31 and the pin 32. The pin 32 extends beyond the bushing 31 in both axial directions and is received within cylindrical cavities defined by the blind holes 16 of the track links 10. The cylindrical cavities of the blind holes 16 include a diameter that is larger than the diameter of the pin 32. Thus, a radial clearance 34 exists between the pin 32 and the blind holes 16. An axial clearance 35 also exists between the pin 32 and the link caps 17 of the blind holes 16. The radial clearance between the bushing 31 and the pin 32, the radial clearance 34 between the pin 32 and the blind holes 16, and the axial clearance 35 between the pin 32 and the blind holes 16 allow the pin 32 to rotate within the bushing 31 and the blind holes 16. By allowing the pin 32 to rotate, the pin 32 may receive a more even wear pattern during the operation of a machine that employs the track chain 21, thereby extending the usable lifetime of the pin 32 or other components of the track chain 21, such as the coupling mechanism 30 or the track link 10.

Although the track link 10 and the track chain 21 are often described herein as an offset track link and an offset track chain, respectively, it will be understood and appreciated that the track link 10 and the track chain 21 may be a straight track link and a straight track chain, respectively. For example, the track chain 21 may alternate between pairs of track links with two bushing apertures 15 and pairs of track links with two blind holes 16. The blind hole 16, or the link cap 17 thereof, may be integral to the track link 10. For example, in some embodiments, the track link 10 is formed of a metallic material through a forging process. During the forging process, the blind hole 16 may be at least partially formed by pressing the inner side 11 of the track link 10 at the second longitudinal end 14 of the track link 10, such as with a cylindrical object, while the metallic material is at least partially molten. In some instances, after such a forging process, the blind hole 16 is later machined to its final shape. However, the track link 10 may be formed in any other appropriate way.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A track link, comprising:
an inner side;
an outer side;
a first longitudinal end including a bushing aperture extending entirely through the track link from the inner side to the outer side; and
a second longitudinal end including a blind hole extending only partially through the track link from the inner side toward the outer side.

2. The track link of claim 1, wherein the bushing aperture and the blind hole are laterally offset.

3. The track link of claim 1, wherein the blind hole forms a link cap and wherein a thinnest portion of the link cap is from approximately 5 mm to 10 mm.

4. The track link of claim 1, wherein the blind hole forms a link cap integral to the track link.

5. The track link of claim 4:
wherein the track link is formed of a metallic material through a forging process; and
wherein the blind hole is machined to a final shape after the forging process.

6. The track link of claim 4, wherein the blind hole is configured to receive a pin with an axial clearance between the pin and the link cap.

7. The track link of claim 4, wherein the link cap is flat on the outer side of the track link.

8. A track link assembly, comprising:
a first track link including a first blind hole extending only partially through the first track link and a first bushing aperture extending entirely through the first track link;
a second track link including a second blind hole extending only partially through the second track link and a second bushing aperture extending entirely through the second track link; and
a coupling assembly coupling the first track link and the second track link via the first blind hole and the second blind hole.

9. The track link assembly of claim 8:
wherein the first and second blind holes are spaced apart along a first axis orthogonal to a longitudinal axis of the track link assembly by a first distance;
wherein the first and second bushing apertures are spared along a second axis orthogonal to the longitudinal axis of the track link assembly by a second distance; and
wherein the first distance is greater than the second distance.

10. The track link assembly of claim 8:
wherein the coupling assembly includes a bushing and a pin disposed within the bushing;
wherein the bushing is press fitted within the first and second bushing apertures;
wherein the pin is at least partially received by the first and second blind holes; and
further comprising a clearance between the pin and the first and second blind holes.

11. The track link assembly of claim 10, wherein the clearance between the pin and the first and second blind holes is a radial clearance.

12. The track link assembly of claim 11, wherein the radial clearance between the pin and the first and second blind holes is from approximately 0.2 mm to 0.6 mm.

13. The track link assembly of claim 10, wherein the first and second blind holes form first and second link caps, respectively, and wherein the clearance between the pin and the first and second blind holes is an axial clearance between the pin and the first and second link caps.

14. The track link assembly of claim 13, wherein the axial clearance between the pin and the first and second link caps is from approximately 0.4 mm to 1 mm.

15. The track link assembly of claim 13, wherein a thickness of the first and second link caps is approximately 5 mm to 10 mm.

16. The track link assembly of claim 10, wherein the pin extends beyond the bushing by a distance equal to at least half of a diameter of the pin.

17. The track link assembly of claim 8, wherein the first track link and the second track link are chiral.

18. A track link, comprising:
an inner side;
an outer side;
a first longitudinal end including a bushing aperture extending entirely through the track link from the inner side to the outer side; and
a second longitudinal end including a blind hole extending only partially through the track link from the inner side toward the outer side and forming a link cap integral to the track link.

19. The track link of claim 18, wherein a thickest portion of the link cap is from approximately 5 mm to 10 mm.

20. The track link of claim 18, wherein the link cap is flat on the outer side of the track link.
